(19) United States
(12) Patent Application Publication
(10) Pub. No.: US 2003/0002651 A1
(43) Pub. Date: Jan. 2, 2003

(54) Data integration with interactive voice response systems

(76) Inventor: Glen E. Shires, Danville, CA (US)

Correspondence Address: PILLSBURY WINTHROP, LLP, P.O. BOX 10500, MCLEAN, VA, 22102, US

(21) Appl. No.: 09/750,029

(22) Filed: Dec. 29, 2000

(51) Int. Cl. H04M 3/00; H04M 5/00

(52) U.S. Cl. 379/265.01; 379/210.01

(57) ABSTRACT

A method and system is provided for data integration with interactive voice response systems. A telephony server receives a request for a call-back, issued by a user at a user station by selecting telephone information service via a web browser. The request may include a phone number to be used for the requested call-back and relevant customer information. The telephony server then places a phone call to a call center that provides the telephone information service and that includes comprising an interactive voice response system, an automatic call distributor, and a customer relation management system. The call, placed by the telephony server to the call center, delivers information relevant to the request to the automatic call distributor and the customer relation management system based on an interactive voice response tree used by the interactive voice response system.

### APPLICATION DATA

Three patent applications are being filed simultaneously that relate to various aspects of live customer support via a call center. The three patent applications are entitled “Data Integration With Interactive Voice Response Systems”, “Automatic Detecting When An Agent Is Available”, and “Matching Routed Call To Agent Workstation”. The subject matter of each is hereby incorporated by reference into each of the others.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

1. Field of the Invention

Aspects of the present invention relate to telephone information services and customer support. Other aspects of the present invention relate to a providing live customer support via a call center.

2. General Background and Related Art

In today's highly competitive market, the quality of customer support often provides a competitive advantage to products and the companies that produce the products. A customer may include a client, a vendor, a user, or an employee. Measures used to quantify the quality of customer support may include the responsiveness of customer support personnel and the skill of the representatives or agents who interact with the customer. Responsiveness may be measured by how long it takes for a customer to receive the telephone information service. Skill of customer support personnel may be measured by how effectively the problem of a customer, that requires customer support, is resolved.

To offer quality customer support, many companies provide call centers which customers may call with questions. These call centers are staffed by agents who help customers during phone conversations. Responsiveness is an indicator of how long a customer has to wait ‘on hold’ until getting to talk to an agent. Skill of customer support personnel can be evaluated based on how many times a customer has to call to resolve the problem. The number of times needed may be attributed to the agent assigned to handle the customer's problems. That is, depending on the nature of the problem, agents with different skills are assigned to handle different categories of problems.

To improve the level of skill, a call center may be designed so as to utilize an effective interactive voice response system which prompts a customer, who calls for support, to answer various predetermined questions by making touch-tone responses on the phone. If these screening questions are carefully designed, they can identify the nature of the problem and help the customer get to agent with the appropriate skills and authority to effectively handle the customer's problem.

The responsiveness of a call center is related, at least in part, to the capacity of the call center and the volume of calls. When a call center has too few agents to provide telephone information service, a customer who calls for help may have to wait a long time until the call is answered by the next available agent. Of course, increasing the number of agents leads to increased cost, including salaries, training and other overhead.

An alternative approach to improving the responsiveness of a call center is to introduce an automated call-back mechanism. Instead of requiring a calling customer to wait in line for an agent to answer the call, an interactive voice response system may be designed to monitor the call center (e.g., the number of customers currently waiting in line and the approximate number of minutes until the calling customer may be answered) and to offer a calling customer the opportunity to choose a call-back option. If the calling customer chooses the call-back option (instead of waiting), the customer is prompted to provide additional information including call-back phone number where the customer can be reached. The entered call-back phone number may then be stored in a queue at the call center, together with other information characterizing the request for help. This other information may specify the nature of the problem and the customer account number. This information can be retrieved later and used by an agent, selected based on the specified problem, to return the customer's call.

Another recently emerged customer service feature, is to allow a customer to activate a phone call to a call center via an Internet web page. Telephone information service offered by a call center may be accessed by clicking a button on a web page. When a customer clicks on the button, a phone call is initiated to the call center that supports the customer service. Currently implemented systems that facilitates such a feature do not forward relevant web-data, which may include information such as customer account number and the specification of the problem, to the call center.

Most of the call centers operating today do not have an automated call-back capability. Even though it would improve the quality of telephone information service by converting existing call centers that do not possess such capabilities to systems that support such capabilities, the conversion may require substantial investment and at the same time, cause disruption of the service provided by the original call center. Integrating existing call centers with web capabilities usually leads to the same consequences. It is beneficial to introduce new technologies that utilize existing call center systems and add new capabilities, such as web activation capability and automated call-back capability, to the existing call centers without introducing any disruption to the systems that are currently in operation.

### BRIEF DESCRIPTION OF THE DRAWINGS

The inventions herein will be explained in terms of exemplary embodiments described in detail with reference to the accompanying drawings in which like reference numerals represent similar parts throughout the several views of the drawings, and wherein:

FIG. 1 is a high level diagram of a telephone information service system utilizing a telephony server;

FIG. 2 is a high level block diagram of an exemplary embodiment of the invention, in which web data is integrated with an interactive voice response system of a call center;

FIG. 3 is an exemplary configuration of a user station;

FIG. 4 is a block diagram of an exemplary Telephony server in relation to a call center;

FIG. 5 describes an exemplary internal structure of a call center;

FIG. 6 shows an exemplary configuration of an agent station; and

FIG. 7 is an exemplary flowchart for integrating web data with an interactive voice response system of a call center.

### DETAILED DESCRIPTION

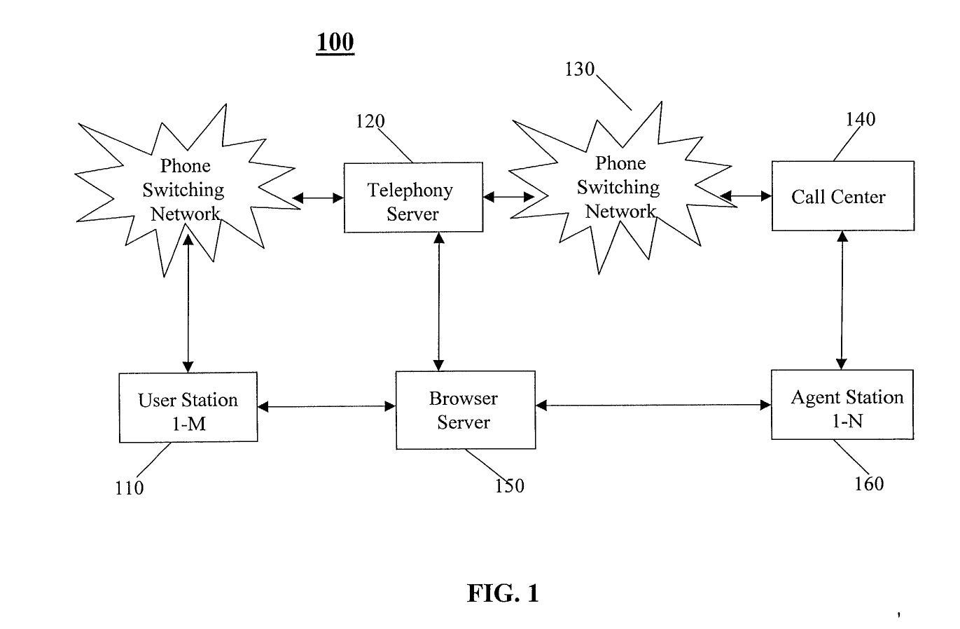

FIG. 1 is a high level block diagram of a system 100, in which a telephony server, connecting a customer, via a browser server, and a call center, facilitates web activation and automated call-back capabilities based on an existing call center that does not possess the web activation and automated call-back capabilities. System 100 includes a user station 110, a browser server 150, a telephony server 120, a phone switching network 130, and an agent station 1-N 160. The Telephony server 120 takes a user request for telephone information service (e.g., request for a call-back), issued by a user at the user station 110 via a web page on the browser server 150 and converts the web request into a conventional phone call to the call center 140, via the phone switching network 130. During the conversion, the Telephony server 120 encodes the web information that is necessary for the call center 140 to execute the requested call-back according to the criteria adopted by an interactive voice response system in the call center 140 so that the encoded results act the same way, in the call center 140, as a conventional customer phone call.

When the call center 140 receives the encoded information, it acts as a conventional call center, selecting an appropriate agent and routing the request to the selected agent. When the agent answers the routed call on a, for example, touch-tone phone, the Telephony server 120 detects the availability of the agent and then automatically connects the agent with the customer who issues the web request for telephone information service.

This arrangement, system 100, addresses the aspects of encoding the information contained in a call-back request, issued via a web page, into a DTMF string in accordance with an interactive voice response tree employed by an interactive voice response system in a call center so that necessary information can be routed appropriately, in the form similar to a phone call, to the call center which can deliver the information encoded in the DTMF strings to an agent.

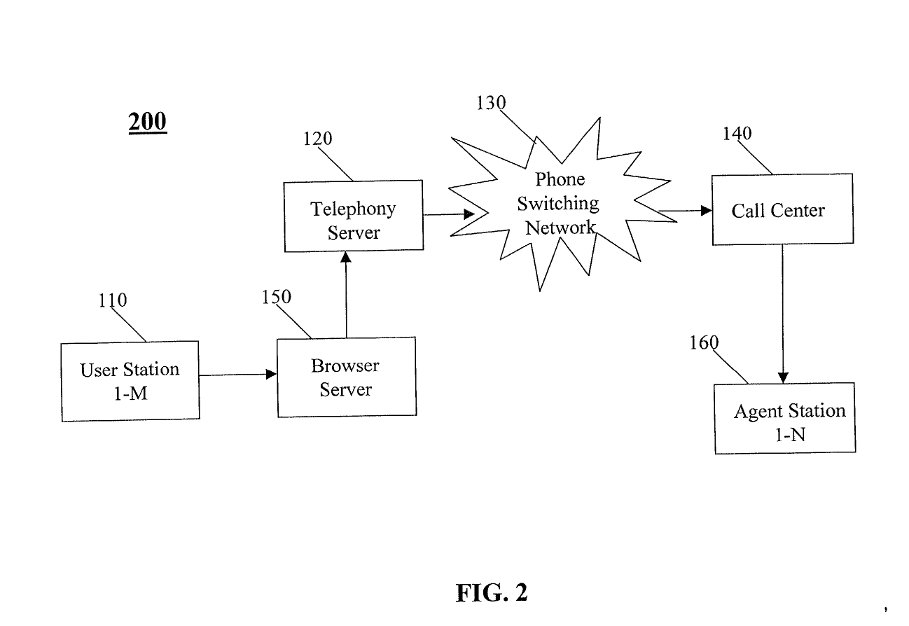

FIG. 2 is a high level block diagram of an exemplary embodiment of the invention, in which data contained in a call-back request, issued by a user on a web page, is integrated with an interactive voice response system of a call center. System 200 includes the user station 110, the browser server 150, the Telephony server 120, the phone switching network 130, the call center 140, and the agent station 1 through N 160. In system 200, a user or a customer, at the user station 110, logs onto a web site, via the browser server 150, from where the customer may seek telephone information service. The web site that provides the telephone information service may be hosted on the browser server 150. To facilitate telephone information service, the Telephony server 120 may implement a button on the web site, representing telephone information service, so that the customer may request telephone information service from the web site by simply clicking on the button.

A request for telephone information service may request a call back from an agent connected to the call center 140. The request may also request telephone information service in a different form. For example, the customer may ask an agent to provide telephone information service through a co-browsing session between the customer and the agent. The customer may also request to get telephone information service through both a call-back as well as a co-browsing session with the agent. A co-browsing session may be helpful when the customer likes to show the agent some content listed on the web such as a bill containing a wrong charge. In this case, the customer may push a web page to the agent during the co-browsing session.

When telephone information service is requested by the customer at the user station 110, relevant information necessary to facilitate the requested telephone information service may be specified by the customer. Such relevant information may include a call-back phone number (if a call-back is requested), a user ID representing the customer's login ID (if a co-browsing session is requested), the nature of the problem that needs telephone information service (so that an appropriate agent with proper skills can be selected), and the account number of the customer.

The request, issued via the web page together with the relevant information, is sent to the Telephony server 120 via the browser server 150. Upon receiving the call-back request, including the relevant information, the Telephony server 120 converts the web request into an appropriate phone call that encodes the relevant information necessary for the requested telephone information service and places the phone call, via the phone switching network 130, to the call center 140.

The call center 140 selects an agent according to the information provided with the request. For example, if a customer has problems with billing and requests telephone information service to solve the billing problem, the call center 140 may choose an agent who has the knowledge and skills related to billing problems. Once the agent is determined, the call center 140 routes the call-back request to the selected agent. The routing may comprise placing a call to the agent station corresponding to the agent and displaying the relevant information supplied with the call-back request by the customer who requested the call-back on a display screen of the agent.

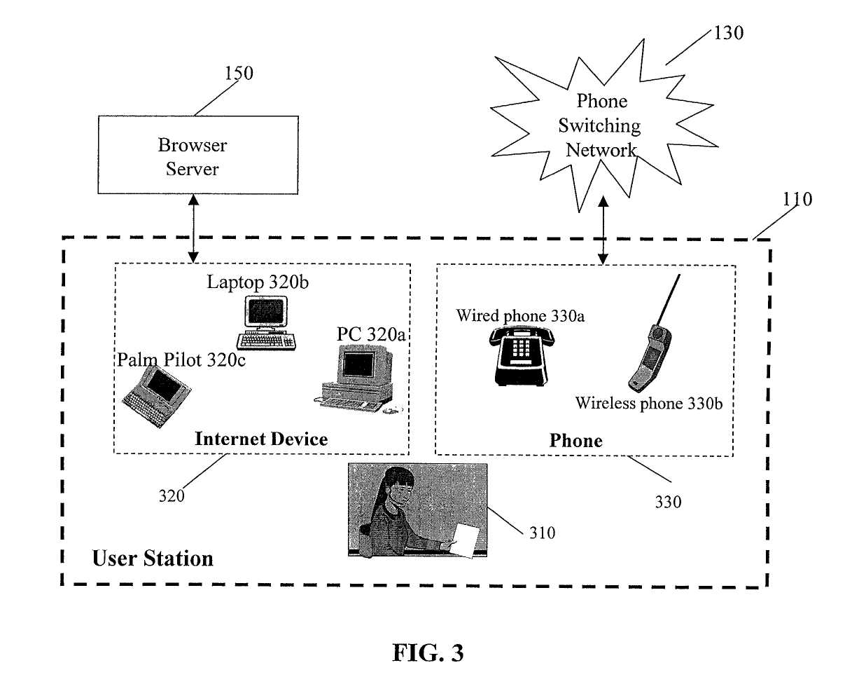

FIG. 3 shows an exemplary configuration of the user station 110. The user station 110 includes a user 310, an Internet device 320, and a phone 330. The Internet device 320 is a device that is capable of connecting to the Internet via a connection, in either wired or wireless fashion. Examples of such a device include a person computer 320a, a laptop 320b, or a Palm Pilot 320c. The user 310 may log onto the browser server via an Internet device 320.

The phone 330 may include a wired phone 330a or a wireless phone 330b. A wireless phone may be a cordless phone or a cellular phone. The user 310 may use the phone 330 to receive a call-back, routed via the phone switch network 130, for telephone information service. The phone switching network 130 may be a conventional Public Switched Telephone Network (PSTN) or a wireless communication network.

When the user 310 chooses, via a web page, telephone information service by clicking on a button on the web page corresponding to telephone information service, the user 310 may be prompted to provide more relevant information, on the web page, that is necessary to complete the requested telephone information service. Such relevant information may include account number, nature of the problem that needs to be resolved through telephone information service, and the phone number for the requested call back. Once such information is collected, the user 310 may submit the request, together with the provided relevant information, via the browser server 150.

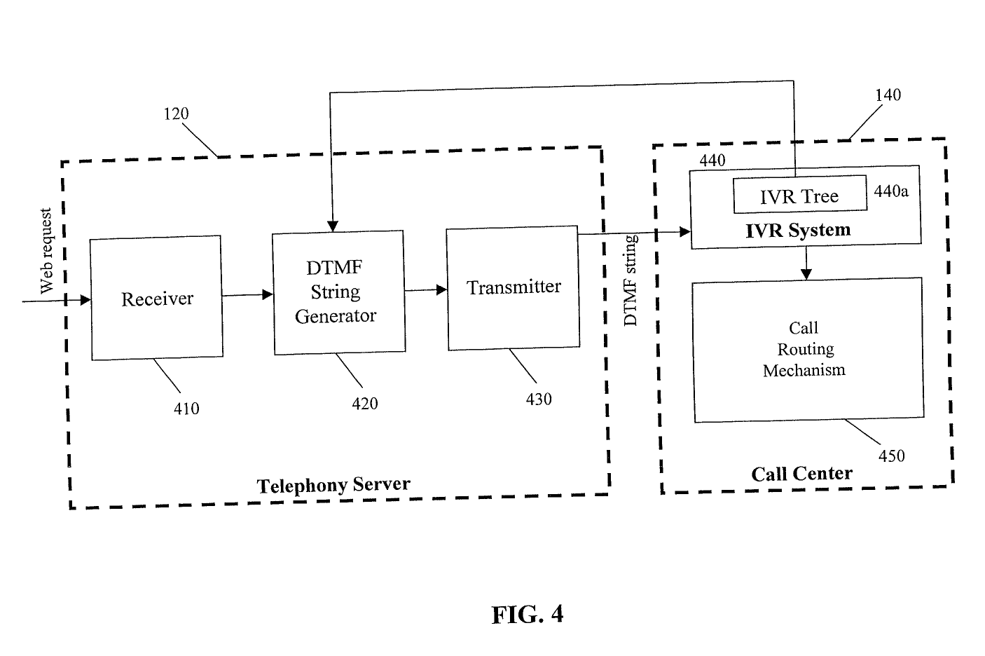

FIG. 4 shows an exemplary block diagram of the Telephony server 120 and how the Telephony server 120 interacts with the call center 140. In FIG. 4, the Telephony server 120 includes a receiver 410, a DTMF (Dual Touch-tone Multi Frequency) string generator 420, and a transmitter 430. The receiver 410 receives a request for a call-back from the user 310, issued from a web page via the browser server 150.

Together with the request, the receiver 410 may also obtain relevant information supplied by the user 310. The receiver 410 may parse the relevant information and separate different pieces of information and label them. The receiver 410 may also extract certain information. For example, the receiver 410 may extract a call-back phone number and a customer account from rest of the information. Correctly parsing different pieces of information allows the Telephony server 120 to encode the call-back request properly before forwarding the request to the call center 140.

The parsed information generated by the receiver 410 is fed to the DTMF string generator 420. The DTMF string generator 420 is to generate a DTMF string that encodes different pieces of the relevant information supplied by the user 310 from the web. The DTMF string generator 420 converts a web request, issued by the user 310, into a phone request, in certain fashion, that can be sent to the call center 140 as a regular phone call request.

Conventionally, when a customer places a phone call to a call center for telephone information service, the customer's call may be answered by an automatic interactive voice response system. The automatic interactive voice response system may ask the customer to answer a series of pre-phrased questions via a touch-tone phone. The questions may be asked in a pre-defined order, which is specified by an interactive voice response tree embedded in the interactive voice response system.

Examples of such questions, asked by a conventional interactive voice response system, include “To establish a new account, press 1, for customer service on your existing account, press 2 . . . ” and “. . . . Please enter your 8-digit account number now . . . ”. The answers from the customer, entered from the phone via touch-tones, are recorded, in this case, as a DTMF string. For example, if the customer presses 2 for customer service on an existing account, as the answer for the first example question, and then entered the account number from the touch-tone phone, as the answer to the second example question, the DTMF string generated based on the answers may be “2P45363432”. In this DTMF string, the first “2” represents the choice for customer service on an existing account, “P” indicates the pause between two different answers, and “45363432” represents the account number of the customer. How a DTMF string is formed depends on the sequence of the questions. That is, the format of a DTMF string is determined by the interactive voice response tree used by the corresponding interactive voice response system.

When a DTMF string encodes information according to the interactive voice response tree, the interactive voice response system is able to identify each piece of information based on their relative positions in the DTMF string. For example, assuming the second question from an interactive voice response tree is to enter the account number, to identify the user's account number, the interactive voice response system can easily locate the account information from a DTMF string by identifying the information between the first pause “P” and the second pause “P”.

In FIG. 4, the DTMF string generator 420 takes the parsed request as input and encodes different pieces of the relevant information into a DTMF string. The encoding is performed according to the interactive voice response tree 440a used by the interactive voice response system 440 of the call center 140. For example, if the user 310 provides, via a web page, the account information in a call-back request, the DTMF string generator 420 generates a DTMF string, in which the account information is inserted at the correct position, defined by the interactive voice response tree 440a. In this way, the interactive voice response system 440 is able to extract the account information from the DTMF string based on their positions.

As another example, if the user 310 issues a call-back request via a web page (instead of via a phone call) and provides account number with the request. The DTMF string generator 420, using the parsed account number from the receiver 410, generates a DTMF string, according to the interactive voice response tree 440a, containing “2P45363432”. To do so, the DTMF string generator 420 may be required to accommodate the interactive voice response tree 440a by automatically creating some of the answers to the questions that are in the interactive voice response tree 44-a but may not be on the web page. One example is the pause “P”. Another example is the answer “2” in the above example of using a phone call to request customer service which may not have a corresponding question on a web page from where the customer may also request customer service. In this case, to generate a proper DTMF string in accordance with the interactive voice response tree 440a, the DTMF string generator 420 may automatically insert a “2P”, in front of the account string “45363432”, into the DTMF string, even though this created answer is not specified by the customer.

Once a DTMF string is generated by the DTMF string generator 420, it is sent, through the transmitter 430, to the call center 140. Since the request is made through a web page and the relevant information associated with the request is encoded directly into a DTMF string, the transmitter 430 inserts directly the DTMF string into the Interactive Voice Response (IVR) system 440 of the call center 140. In effect, compared with a conventional phone call for customer service, in which a DTMF string is generated based on the customer's responses on the phone, the Telephony server 120 generates a call to the call center 140 by automatically generating the DTMF string based on a web request, and inserts the DTMF string directly into the IVR system 440 of the call center 140. Once the call center 140 receives the DTMF string, it uses the information encoded in the DTMF string to route the call to an appropriate agent via a call routing mechanism 450.

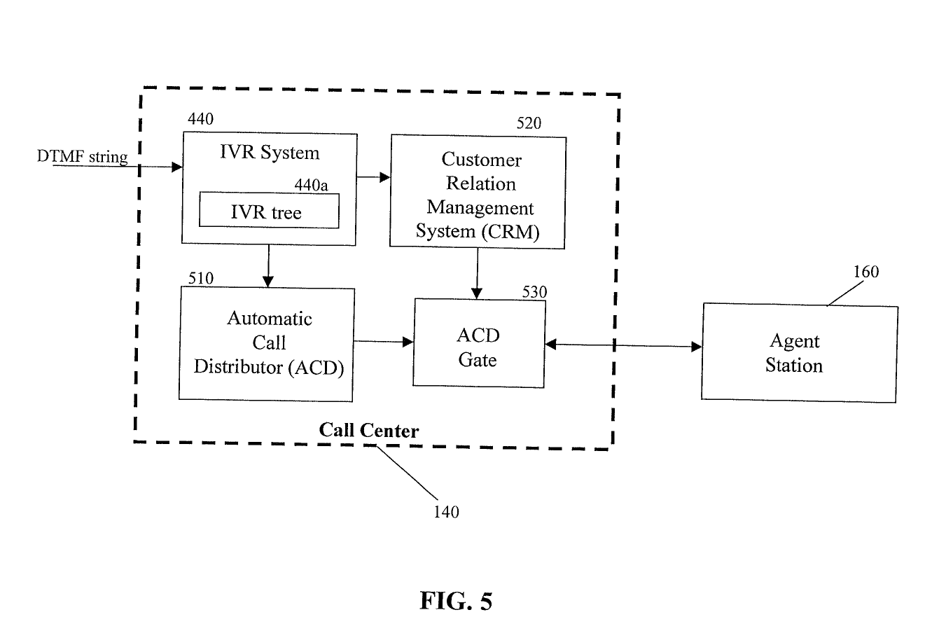

The call center 140 is described in more detail in FIG. 5. The call center 140, illustrated in FIG. 5, includes an Interactive Voice Response (IVR) system 440 embedded with an IVR tree 440a, an Automatic Call Distributor (ACD) 510, a Customer Relation Management (CRM) system 520, and an ACD gate 530. The call center 140 accepts a request via its IVR system 440 via a DTMF string, encoded according to the IVR tree 440a (which defines a sequence of questions), and inserts appropriate information into the ACD 510 or the CRM 520.

Certain information needs to be inserted into the CRM system 520. For example, in order to maintain a good customer relationship, it may be helpful to record the information about which customer needs customer service when with what problem and how often. To effectively route a call to an agent for customer service, it may be helpful to know what problem the customer is having so that an appropriate agent with needed skills can be assigned to help the customer to solve the problem.

With appropriate information, gathered from the user 310 on the web, directly inserted into the call center 140 in the form of a DTMF string, in effect, the call center 140 receives a request, similar to a request made through a phone call. The ACD 510 then selects an agent according to the needed skills to solve the problem that the customer is having. The request is then sent to the selected agent, via the ACD gate 530, in the form of a routed call to the agent station 160.

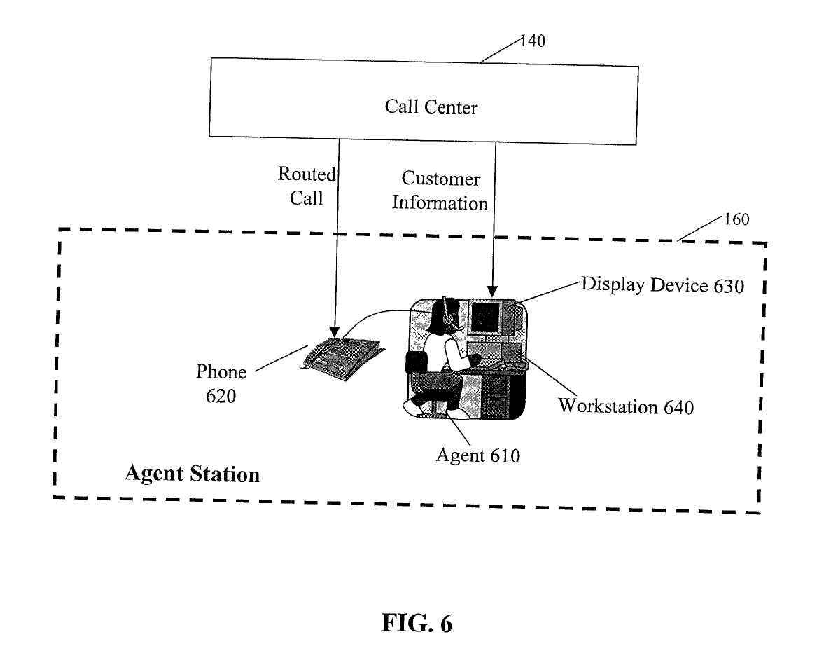

FIG. 6 shows an exemplary configuration of the agent station 160. An agent station connects to the call center 140 and includes an agent 610, a phone 620, a display device 630, and a worskstation 640. A call requesting a call-back for telephone information service is routed to the phone 620 at the agent station 160 as a routed call from the call center 140. When the routed call reaches the phone 620, it rings. When the agent 610 answers the routed call, customer information related to the requested call-back (e.g., customer account) is sent from the call center 140 to the agent station 160 and displayed on the display device 630 of the workstation 640.

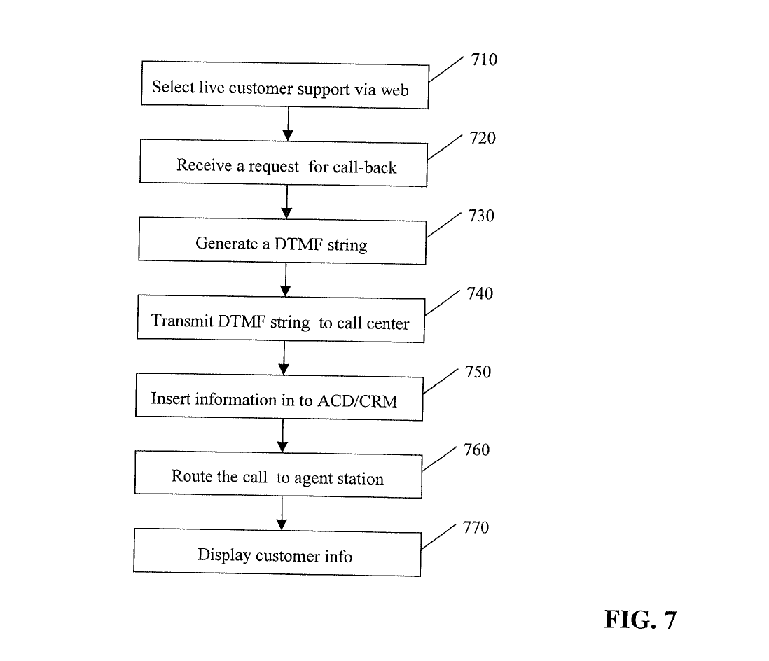

FIG. 7 is an exemplary flowchart of the process, in which a web generated request for a call-back for telephone information service, with the relevant information entered together with the request, is routed, through a call center, to an agent with relevant information automatically displayed on the agent's display screen. In FIG. 7, a customer first selects, at act 710, telephone information service on a web page by clicking a button representing telephone information service. The request may include the information relevant to the request call-back such as customer account information and the phone number to be used for the call-back.

The request, together with the relevant information, is received, at act 720, by the Telephony server 120. Based on the IVR tree 440a of the IVR system 440, the Telephony server 120 generates, at act 730, a DTMF string that encodes the request and the relevant information according to the IVR tree 440a.

The generated DTMF string is then sent, at act 740, from the Telephony server 120 to the IVR system 440 of the call center 140. Different pieces of information, contained in the relevant information and parsed and encoded according to the IVR tree 440a, are inserted, at act 750, into the ACD system 510 and the CRM system 520 of the call center 140. Based on the relevant information, the ACD system 510 then selects appropriate agent with requested skills and routes the request for a call-back, at act 760, to the selected agent. When the agent answers the routed call, the call center 140 routes, at act 770, the relevant information to the display screen of the agent station of the workstation 640.

In the preferred embodiment, the telephone information service is a customer support center. However, this invention is not limited to customer support, but equally applicable to telephone services used for sales, pre-sales, information distribution and polling. While in the preferred embodiment described below, users of the system are customers, this invention equally applies to users who are employees, vendors, clients or potential future customers. The preferred embodiment also uses a web browser for the agent and customer, but the invention equally applies to other networked client applications.

The processing described above may be performed by a general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and, materials, such as are within the scope of the appended claims.

What is claimed is:

1. A method for data integration with interative voice response systems, the method comprising:
receiving, by a telephony server, a request for a call-back issued by a user at a user station by selecting telephone information service via a browser, the request including a telephone number, to be used for the call-back, and user information; and
placing a call, by the telephony server, to a call center that facilitates the telephone information service, through a phone connection, the call center comprising an interactive voice response system, the call delivering information relevant to the request to the call center according to an interactive voice response tree used by the interactive voice response system.

2. The method according to claim 1, wherein the user information includes user's account information.

3. The method according to claim 1, wherein placing a call comprises:
generating a string of DTMF codes encoding the user information based on the interactive voice response tree;
transmitting the string of DTMF codes to the call center.

4. The method according to claim 3, further comprising:
routing, by the call center, the call to an agent station; and
presenting the user information, decoded from the string of DTMF codes, on the agent station.

5. A system for data integration with interative voice response systems, the system comprising:
a user's telephone and a user's device with network connection to access data on a browser;
a call center providing a telephone information service;
a telephony server for data integration connecting to both the user's browser, via a browser server, and the call center, via a phone switching network, the telephony server receiving a request for a call-back issued from a user via the user's browser, wherein the request includes a phone number for the call-back and user information, the telephony server placing a call, based on the request, to the call center and delivering the user information to the call center.

6. The system according to claim 5, wherein the device is a personal computer.

7. The system according to claim 5, wherein the device is a personal digital assistant device.

8. The system according to claim 5, wherein the device is a laptop computer.

9. The system according to claim 5, wherein the device is a wireless personal digital assistant device.

10. The system according to claim 5, wherein the call center comprises:
an interactive voice response system for interactively responding a call, via voice, based on an interactive voice response tree;
an automatic call distributor for routing the call to an agent at an agent station; and
an automatic call distribution gate for selectively connecting a routed call to the agent station.

11. The system according to claim 5, wherein the call center comprises:
an interactive voice response system for interactively responding a call via voice based on an interactive voice response tree; and
a customer relation management system for storing, retrieving, and managing user information.

12. The system according to claim 5, wherein the call center comprises:
an interactive voice response system for interactively responding a call via voice based on an interactive voice response tree;
an automatic call distributor for routing the call to an agent at an agent station;
a customer relation management system for storing, retrieving, and managing user information; and
an automatic call distribution gate for selectively connecting a routed call to the agent station.

13. The system according to claim 5, wherein the telephony server comprises:
a receiver for receiving, from the browser server, the request issued by the user;
a DTMF code generator for generating a string of DTMF codes encoding the user information based on the interactive voice response tree; and
a transmitter for transmitting the DTMF string to the call center by delivering the string of DTMF codes to the interactive voice response system of the call center.

14. The system according to claim 5, further comprising at least one agent station connecting to the call center.

15. The system according to claim 14, wherein the agent station comprises:
a telephone for receiving and answering a routed call from the call center;
a display screen for information display; and
a presentation unit for receiving the user information, sent with the routed call, and for displaying the user information on the display screen.

16. A computer readable medium having program code stored thereon, such that when the code is read and executed by a computer, the computer is caused to:
receive, by a telephony server, a request for a call-back issued by a user by selecting a telephone information service via a browser, the request including a telephone number, to be used for the call-back, and user information; and
place a call, by the telephony server, to a call center that facilitates the telephone infomration service, through a phone connection, the call center comprising an interactive voice response system, the call delivering information relevant to the request to the call center according to an interactive voice response tree used by the interactive voice response system.

17. A medium according to claim 16, wherein the code recorded on the medium further causes the computer to:
receive, by the telephony server, the request;
generate a string of DTMF codes encoding the user information based on the interactive voice response tree; and
transmit the string of DTMF codes to the call center.

18. A medium according to claim 17, wherein the information recorded on the medium further causes the computer to:
route, by the call center, the call to an agent station; and
present the user information, decoded from the string of DTMF codes, on the agent station.
